(19) United States
(12) Patent Application Publication
(10) Pub. No.: US 2017/0171700 A1
(43) Pub. Date: Jun. 15, 2017

(54) METHOD AND SYSTEM FOR ASSOCIATING LOCATION ATTESTATIONS WITH DERIVED LOCATION DATA

(71) Applicants: Antonio Sabarez, II, Monterey, CA (US); Abel Gonzalez, Salinas, CA (US); Alvaro Gonzalez, Salinas, CA (US)

(72) Inventors: Antonio Sabarez, II, Monterey, CA (US); Abel Gonzalez, Salinas, CA (US); Alvaro Gonzalez, Salinas, CA (US)

(21) Appl. No.: 14/497,143

(22) Filed: Sep. 25, 2014

(51) Int. Cl. H04W 4/02; G06Q 50/02

(52) U.S. Cl. CPC H04W 4/02; G06Q 50/02

(57) ABSTRACT

A mobile communications device is adapted to receive user input for association with a defined geographic area or location. The user inputs an attestation of his or her location and the mobile device compares the user-attested location with a geolocational data derived from external transmitters, such satellites as the Global Positioning System (“GPS”). The geolocational data is compared with user attested location and additional optional steps include (a.) alerting one or more other devices when the user attested location is not confirmed by the geolocational data; (b.) the device may inhibit further input of data for association with the user attested location; and/or (c.) the device may accept additional user input without notifying the user of the apparent discrepancy between the user attested location and the geolocational data.

### CLAIM FOR PRIORITY

The present application is a continuation-in-part application for patent of currently pending U.S. patent application Ser. No. 13/347,702 titled “METHOD, SYSTEM AND DEVICE FOR A GEOLOCATIONAL TRACKING AND MANAGEMENT OF AGRICULTURAL WORKFLOW” filed on Jan. 11, 2012. The present application claims the priority date of filing for this U.S. patent application Ser. No. 13/347,702. Furthermore, U.S. patent application Ser. No. 13/347,702 is incorporated into the present disclosure in its entirety and for all purposes.

The present application is also continuation-in-part application for patent of currently pending U.S. patent application Ser. No. 13/948,594 titled “METHOD, APPARATUS AND SYSTEM FOR TRANSPARENT TRACKING OF WORKER PERFORMANCE” filed on Jul. 23, 2013.

The present application claims the priority date of filing for this U.S. patent application Ser. No. 13/948,594. Furthermore, U.S. patent application Ser. No. 13/948,594 is incorporated into the present disclosure in its entirety and for all purposes.

### FIELD OF THE INVENTION

The present invention relates generally to methods and systems of agricultural process monitoring and management, and more particularly to associating aspects and elements of agricultural production, processing and delivery with defined areas of harvesting, sourcing or production of agricultural goods.

### BACKGROUND OF THE INVENTION

Information technology is being increasingly applied in efforts to improve food safety practices. Reliable identification of the source of initial input of agricultural goods into the stream of commerce is especially important in tracking the flow of goods from farm, forest or fish harvesting location to the consumer's table. Towards this end, mobile devices may be employed to accept data input at a specified location or area from where tracking of an agricultural good is initiated or continued.

The prior art, however, fails to optimally provide systems and methods that confirm the validity of a locational attestation made by a user of a mobile communications device in view of an independently and contemporaneously determined location of that mobile communications device. The prior art further fails to optimally provide optional methods of either informing other parties of, and annotating records associated with, findings of discrepancies of device user location reporting with independently generated geolocational indications of device position.

In addition to food safety issues, producers and shippers of agricultural products would benefit from improvements in confirming user attestations of locations of agricultural goods by increasing the opportunities to support quality levels of agricultural goods in the stream of commerce. By increasing the reliability of user reported locations in food safety tracking, numerous actors and agents active in the agricultural streams of commerce could more effectively isolate and address both particular incidents of concern and systemic failures in agricultural practices.

### SUMMARY OF THE INVENTION

These and other objects of the present invention are made obvious in light of this disclosure, wherein methods, systems and computer-readable media for monitoring and managing agricultural production process are provided by the method of the present invention (hereinafter, “the invented method”). According to a first aspect of the method of the invented method, a mobile communications device (hereinafter, “mobile device”) is adapted to receive user input for association with a defined geographic area or location. The user inputs an attestation of his or her location into the mobile device and the mobile device compares the user-attested location with a geolocational data derived from external transmitters, such satellites as the Global Positioning System (“GPS”). The geolocational data may optionally be compared with user-attested location by the mobile device and/or one or more other communicatively coupled devices.

Additional optional steps of the invented method include (a.) alerting one or more other devices when the user attested location is not confirmed by independently acquired geolocational data, e.g., GPS data; (b.) inhibiting further input of data into the mobile device for association with the user attested location; and/or (c.) the mobile device accepting additional user input without notifying the user of the apparent discrepancy between the user attested location and the geolocational data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an electronics communications network comprising the Internet, a GPS source, a mobile device, a telephony network, a network computer and a database server;

FIG. 2 is a block diagram of the mobile device of FIG. 1;

FIG. 3 is a block diagram of the network computer of FIG. 1;

FIG. 4 is a block diagram of the database server of FIG. 1;

FIG. 5 is a flowchart of the invented method involving the collection and verification of GPS data by a mobile device;

FIG. 6 is a flowchart of an optional addition to the method of FIG. 5, whereby an alert is issued to a user;

FIG. 7 is a flowchart of a further optional addition to the method of FIG. 5, whereby a data record is marked;

FIG. 8 is a flowchart of a aspects of the invented method relating to the reception and handling of communications between the mobile device and the network computer of FIG. 1;

FIG. 9 is a flowchart of additional optional aspects of the invented method relating to the reception and handling communications between the mobile device and the network computer of FIG. 1;

FIG. 10A is a block diagram of an exemplary area record update request message of step 5.06 of FIG. 5;

FIG. 10B is a block diagram of an exemplary area record update message of step 8.04 of FIG. 8;

FIG. 10C is a block diagram of an exemplary area record of FIGS. 2, 3, 4 and 5;

FIG. 10D is a block diagram of an exemplary first input alert message of FIG. 5;

FIG. 10E is a block diagram of an exemplary second input alert message data record update request message of FIG. 5;

FIG. 10F is a block diagram of an exemplary override message of FIG. 5;

FIG. 10G is a block diagram of an exemplary area message of FIG. 5;

FIG. 10H is a block diagram of an exemplary first device activity message of FIG. 8;

FIG. 10I is a block diagram of an exemplary second device activity message of FIG. 8;

FIG. 11A is a block diagram of the data base management system of the mobile device of FIG. 1 and FIG. 2 maintaining electronic messages and electronic records of FIG. 10A through FIG. 10I;

FIG. 11B is a block diagram of the network computer data base management system of the network computer of FIG. 1 and FIG. 3 maintaining electronic messages and electronic records of FIG. 10A through FIG. 10I;

FIG. 11C is a block diagram of the Database server base management system of the database server of FIG. 1 and FIG. 4 maintaining electronic messages and electronic records of FIG. 10A through FIG. 10I;

FIG. 12 is an illustration of a visual rendering of a user interface of the mobile device of FIG. 1 and FIG. 2.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

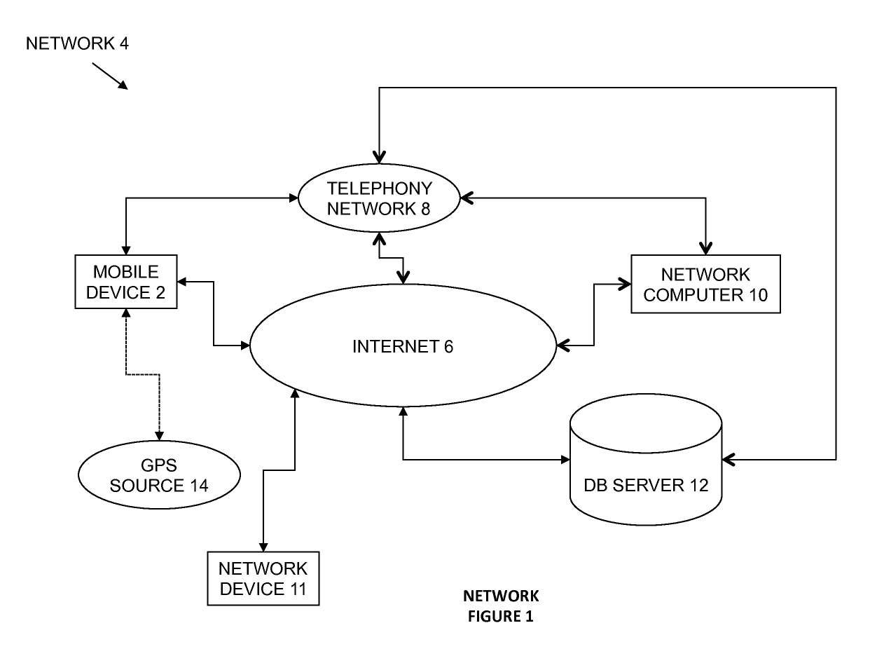

Referring now generally to the Figures and particularly to FIG. 1, FIG. 1 is a presents a mobile device 2 comprised within an electronics communications network 4 (herein “network 4”). The network 4 further optionally comprises the Internet 6, a telephony network 8, one or more network computers 10, one or more network devices 11, one or more database servers 12, and a GPS source 14. The mobile device 2, the one or more network computers 10, the one or more network devices 11, and the one or more database servers 12 are each computational devices. The GPS source 14 provides signals to the mobile device 2, one or more network computers 10 and one or more database servers 12, wherein the signals indicate geolocational and/or time data sourced from a space-based satellite navigation system Global Positioning System (hereinafter, “GPS”).

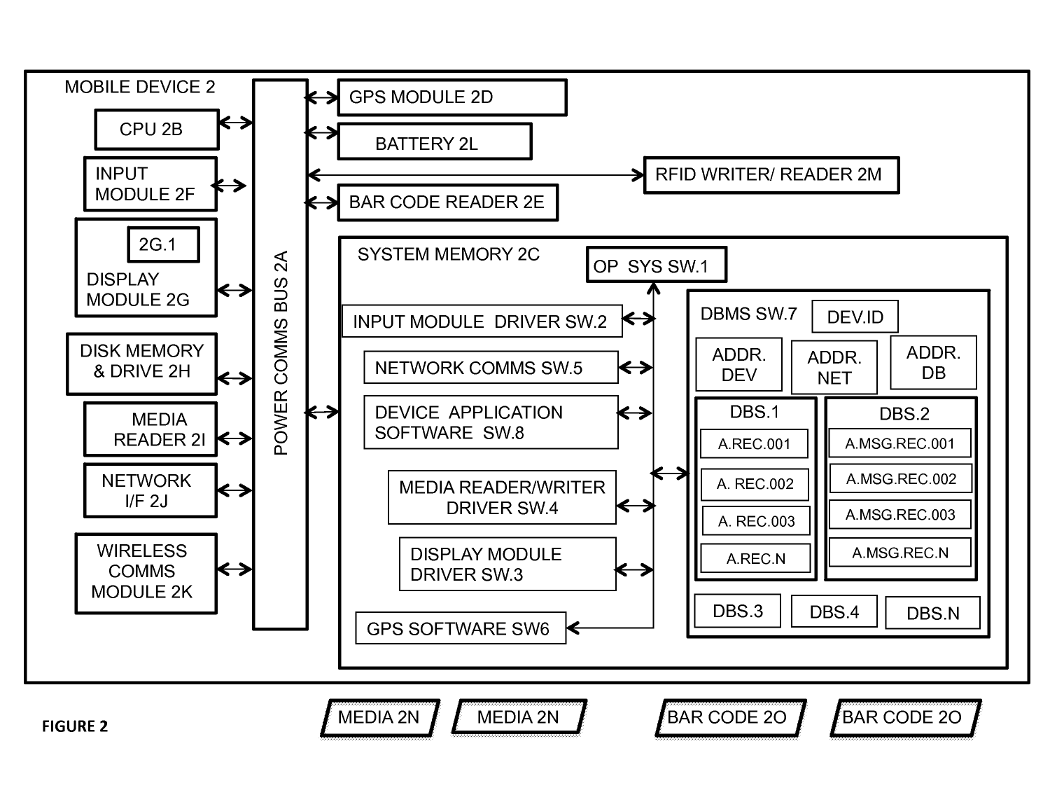

Referring now generally to the Figures and particularly to FIG. 2, FIG. 2 is a schematic of the mobile device 2 of FIG. 1. It is understood that one, more than one, or all of the elements and aspects of the mobile device 2 may also be present in one or more network computers 10 and/or database servers 12.

An internal power and communications bus 2A bi-directionally communicatively couples a central processing unit 2B (“CPU” 2B), a system memory 2C, a GPS module 2D, a visual pattern bar code reader 2E, a data input module 2F, a display module 2G having a display screen 2G1, a disk memory, controller and disk memory module 2H, an electronic media reader 2I, a network interface module 2J, a wireless communications module 2K, and an RFID writer/reader 2M. A battery 2L is further coupled with the mobile device 2 elements 2A-2K by means of the power and communications bus 2A and provides electrical power to the elements 2A-2K of the mobile device 2. The electronic media reader 2I and each of a plurality of electronic media 2N are selected are configured to enable the transfer of software encoded data and instructions between the mobile device 2 and the electronic media 2N.

The bar code reader 2E and each of a plurality of bar code patterns 2O are selected and configured to enable the transfer of encoded identifiers, data and instructions as encoded in the bar code pattern 2O and the electronic media 2N. An RFID reader/writer 2M and a plurality of RFID devices 2P are selected and configured to communicate, store and/or exchange information.

The mobile device 2 system memory 2C has various software programs and utilities stored therein, to include, but not limited to, an operating system SW.1, an input module driver software SW.2, a display module driver software SW.3, a media reader module driver software SW.4, a network communications software SW.5, a GPS software SW.6, a database management software SW.7 (hereinafter “DBMS” SW.7) and a device software application. The DBMS DBSW.7 stores a device identifier DEV.ID, a device network address ADDR.DEV, a network computer network address ADDR.NET, a database server network address ADDR.DB, and further includes a plurality of software databases DBS.1, DBS.2, DBS.3 & DBS.N. The device identifier DEV.ID preferably uniquely identifies the mobile device 2 to the network computer 10 and the database server 12 (or, “DB server” 12). A device software application SW.8 enables and directs the mobile device 2 in the performance of the steps and aspects of the invention as presented in the Figures and disclosed in accompanying text.

The operating system software SW.1 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7 ™ operating system as marketed by Microsoft Corporation of Redmond, Wash.; or the MAC OS X operating system or iPhone G4 OS™ as marketed by Apple, Inc. of Cupertino, Calif.

The database management system DBMS DBSW.7 may be or comprise an object oriented database management system (“OODBMS”) and/or a relational database management system (“RDBMS”), and one or more databases DBS.1-DBS.N may be or comprise an object oriented database and/or a relational database. The DBMS DBSW.7 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; and the Advantage Database Server™ relational database management system.

The mobile device 2 may be or comprise (a.) an IPHONE™ cellular telephone as marketed by Apple, Inc. of Cupertino; (b.) an IPAD™ tablet computer adapted for generation of digitized photographic documents and capable of bi-directional communications via the telephony network 8 and the Internet 6 as marketed by Apple, Inc. of Cupertino, Calif.; (c.) are HTC TITAN II™ cellular telephone as marketed by AT&T. Inc. of Dallas, Tex. and running a WINDOWS 7™ operating system as marketed by Microsoft Corporation of Redmond, Wash.; (d.) a GALAXY NEXUS™ smart phone as marketed by Samsung Group of Seoul, Republic of Korea and running an ANDROID™ operating system as marketed by Google, Inc. of Mountain View, Calif.; (e.) a TOUGHPAD™ tablet computer as marketed by Panasonic Corporation of Kadoma, Osaka, Japan and running an ANDROID™ operating system as marketed by Google, Inc, of Mountain View, Calif.; or (f.) other suitable portable computational system or electronic communications device known in the art.

The device software application directs the mobile device 2 and the elements 2A through 2M to execute, instantiate and/or comply with the software-enabled aspects of the invented method. The input module driver software SW.2 directs and enables the CPU 2B and the input module 2F in receiving and recording in the system memory data and commands received from the input module 2F, wherein the input module may be a computer keyboard and/or a point and click selection device, or other suitable user input device known in the art. The display module software module SW.3 directs and enables the CPU 2B and the video display module 2G in rendering commands, messages, data and graphics via the video display module 2G. The media reader/writer driver software SW.4 directs and enables the CPU 2B and the media reader/writer in sending and receiving information to and from the media 2N. The network communications software SW.2 directs and enables the CPU 2B and the mobile device 2 in general to bi-directionally communicate with the network 4.

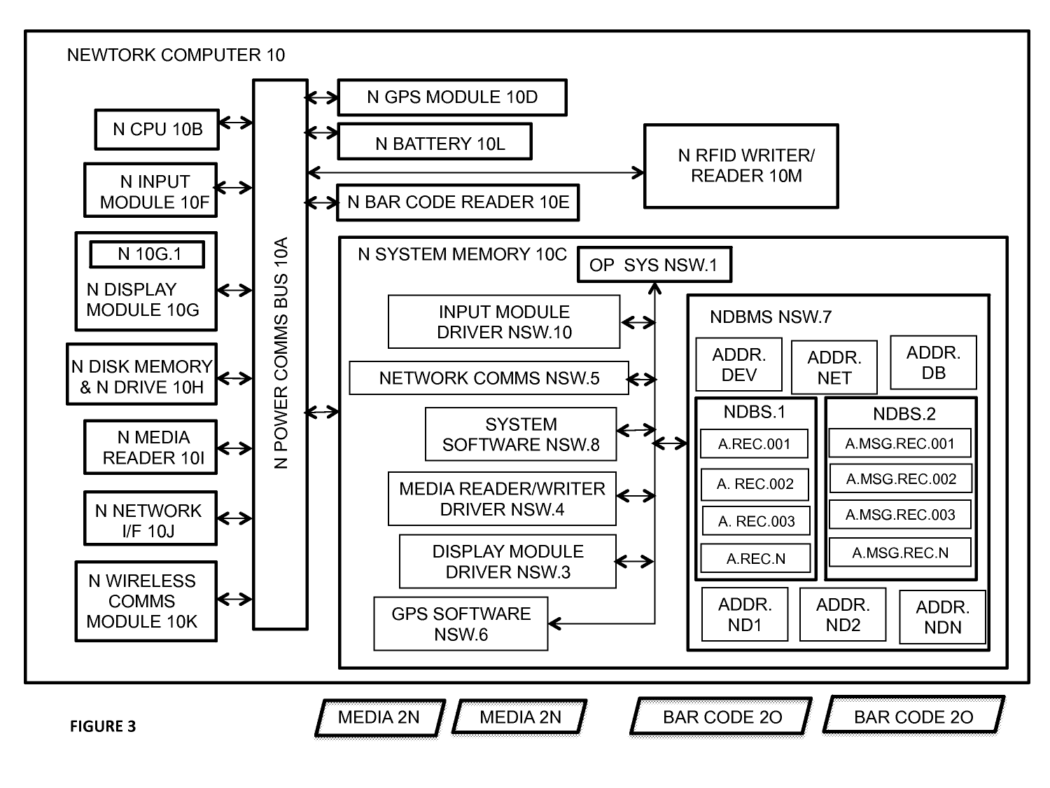

Referring now generally to the Figures and particularly to FIG. 3, FIG. 3 is a schematic of network computer 10 of FIG. 1. It is understood that one, more than one, or all of the elements and aspects of the network computer 10 may also be present in one or more mobile devices 2 and/or database servers 12.

An N internal power and communications bus 10A bi-directionally communicatively couples an N central processing unit 10B (“CPU” 10B), an N system memory 10C, an N GPS module 10D, an N visual pattern bar code reader 10E, an N data input module 10F, an N display module 10G having an N display screen 10G.1, an N disk memory, controller and disk memory module 10H, an N electronic media reader 10I, an N network interface module 10J, an N wireless communications module 10K, and an N RFID writer/reader 10M. An N battery 10L is further coupled with the network computer 10 elements 10A-10K by means of the N power and communications bus 10A and provides electrical power to the elements 10A-10K of the network computer 10. The N electronic media reader 10I and each of a plurality of electronic media 2N are selected are configured to enable the transfer of software encoded data and instructions between the network computer 10 and the N electronic media 2N.

The N bar code reader 10E and each of a plurality of bar code patterns 2O are selected and configured to enable the transfer of encoded identifiers, data and instructions as encoded in the bar code pattern 2O and the electronic media 2N. An N RFID reader/writer 10M and the plurality of RFID devices 2P are selected and configured to communicate, store and/or exchange information.

The network computer 10 N system memory 10C has various software programs and utilities stored therein, to include, but not limited to, a network computer system operating system NSW.1, a network computer input module driver software NSW.2, a network computer display module driver software NSW.3, a network computer media reader module driver software NSW.4, a network computer network communications software NSW.5, a network computer GPS software NSW.6, a network computer database management software NSW.7 (hereinafter “NDBMS” NSW.7) and a network computer system software NSW.8. The NDBMS NSW.7 stores the device network address ADDR.DEV, the network computer network address ADDR.NET, the database server network address ADDR.DB, one or more network device addresses ADDR.ND1-ADDR.NDN and further includes a plurality of a network computer software databases NDBS.1, NDBS.2, NDBS.3 & NDBS.N. The a network computer system software NSW.8 enables and directs the network computer 10 in the performance of the steps and aspects of the invention as presented in the Figures and disclosed in accompanying text.

The a network computer operating system software NSW.1 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7™ operating system as marketed by Microsoft Corporation of Redmond, Wash.; or the MAC OS X operating system or iPhone G4 OS™ as marketed by Apple, Inc. of Cupertino, Calif.

The a network computer database management system NDBMS NSW.7 may be or comprise an object oriented database management system (“OODBMS”) and/or a relational database management system (“RDBMS”), and one or more a network computer databases NDBS.1-NDBS.N may be or comprise an object oriented database and/or a relational database. The NDBMS NSW.7 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; and the Advantage Database Server™ relational database management system.

The network computer 10 and/or one or more network devices 11 may be or comprise (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7 ™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea or and running an ANDROID™; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable computational system or electronic communications device known in the art.

The a network computer network system software NSW 8 directs the network computer and the elements 10A through 10M to execute, instantiate and/or comply with the software-enabled aspects of the invented method. The N input module driver software NSW.2 directs and enables the N CPU 10B and the N input module 10F in receiving and recording in the system memory data and commands received from the N input module 10F, wherein the N input module 10F may be a computer keyboard and/or a point and click selection device, or other suitable user input device known in the art. The a network computer display module software module NSW.3 directs and enables the N CPU 10B and the N video display module 10G in rendering commands, messages, data and graphics via the N video display module 10G. The a network computer media reader/writer driver software NSW.4 directs and enables the N CPU 10B and the media reader/writer in sending and receiving information to and from the media 2N. The a network computer network communications software NSW.2 directs and enables the N CPU 10B and network computer 10 in general to bi-directionally communicate with the network 4.

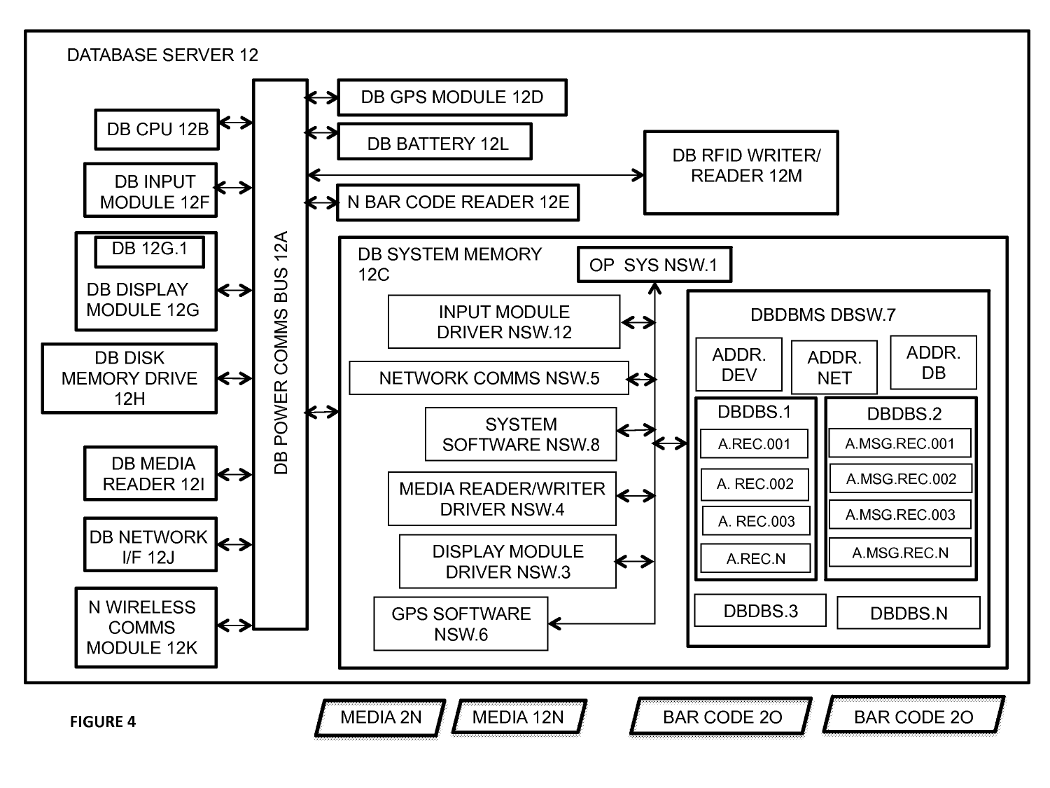

Referring now generally to the Figures and particularly to FIG. 4, FIG. 4 is a schematic of DB server 12 of FIG. 1. It is understood that one, more than one, or all of the elements and aspects of the DB server 12 may also be present in one or more mobile devices 2 and/or network computer 10.

A DB server internal power and communications bus 12A bi-directionally communicatively couples a DB server central processing unit 12B (hereinafter, “DB CPU” 12B), a DB server system memory 12C, a DB server GPS module 12D, a DB server visual pattern bar code reader 12E, a DB server data input module 12F, a DB server display module 12G having a DB server display screen 12G.1, a DB server disk memory, controller and disk memory module 12H, a DB server electronic media reader 121, a DB server network interface module 12J, a DB server wireless communications module 12K, and a DB server RFID writer/reader 12M. A DB server battery 12L is further coupled with the DB server 12 elements 12A-12K & 12M by means of the DB server power and communications bus 12A and provides electrical power to the elements 12A-12K & 12M of the network computer 12. The DB server electronic media reader 121 and each of a plurality of electronic media 2N are selected are configured to enable the transfer of software encoded data and instructions between the DB server 12 and the electronic media 2N.

The DB server bar code reader 12E and each of a plurality of bar code patterns 2O are selected and configured to enable the transfer of encoded identifiers, data and instructions as encoded in the bar code pattern 2O and the electronic media 2N. A DB server RFID reader/writer 12M and the plurality of RFID devices 2P are selected and configured to communicate, store and/or exchange information.

The DB server 12 DB system memory 12C has various software programs and utilities stored therein, to include, but not limited to, a DB server operating system DBSW.1, a DB server input module driver software DBSW.2, a DB server display module driver software DBSW.3, a DB server media reader module driver software DBSW.4, a DB server network communications software DBSW.5, a DB server GPS software DBSW.6, a DB server database management software DBSW.7 (hereinafter “DBDBMS” DBSW.7) and a DB server system software DBSW.8. The DBDBMS DBSW.7 stores the device network address ADDR.DEV, the network computer network address ADDR.NET, the database server network address ADDR.DB and further includes a plurality of software databases DBDBS.1, DBDBS.2, DBDBS.3 & DBDBS.N. The DB server system software DBSW.8 enables and directs the DB server 12 in the performance of the steps and aspects of the invention as presented in the Figures and disclosed in accompanying text.

The DB server operating system software DBSW.1 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7™ operating system as marketed by Microsoft Corporation of Redmond, Wash.; or the MAC OS X operating system or iPhone G4 OS™ as marketed by Apple, Inc. of Cupertino, Calif.

The DB server database management system DBDBMS DBSW.7 may be or comprise an object oriented database management system (“OODBMS”) and/or a relational database management system (“RDBMS”), and one or more databases DBDBS.1-DBDBS.N may be or comprise an object oriented database and/or a relational database. The DBDBMS DBSW.7 may be selected from prior art database management systems including, but not limited to, Objectivity/DB 10™ marketed by Objectivity, Inc. of Mountain View, Calif.; a Database 2™, also known as DB2™, relational database management system as marketed by IBM Corporation of Armonk, N.Y.; and the Advantage Database Server™ relational database management system.

The DB server 12 may be or comprise (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea or and running an ANDROID™; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable computational system or electronic communications device known in the art.

The DB server system software DBSW.8 directs the DB server 12 and the elements 12A through 12M to execute, instantiate and/or comply with the software-enabled aspects of the invented method. The DB server input module driver software DBSW.2 directs and enables the DB CPU 12B and the DB server input module 12F in receiving and recording in the system memory data and commands received from the DB server input module 12F, wherein the DB server input module 12F may be a computer keyboard and/or a point and click selection device, or other suitable user input device known in the art. The DB server display module software module DBSW.3 directs and enables the DB CPU 12B and the DB server video display module 12G in rendering commands, messages, data and graphics via the DB server video display module 12G. The DB server media reader/writer driver software DBSW.4 directs and enables the DB CPU 12B and the DB server media reader/writer in sending and receiving information to and from the media 2N. The DB server network communications software DBSW.2 directs and enables the DB CPU 12B and DB server 12 in general to bi-directionally communicate with the network 4.

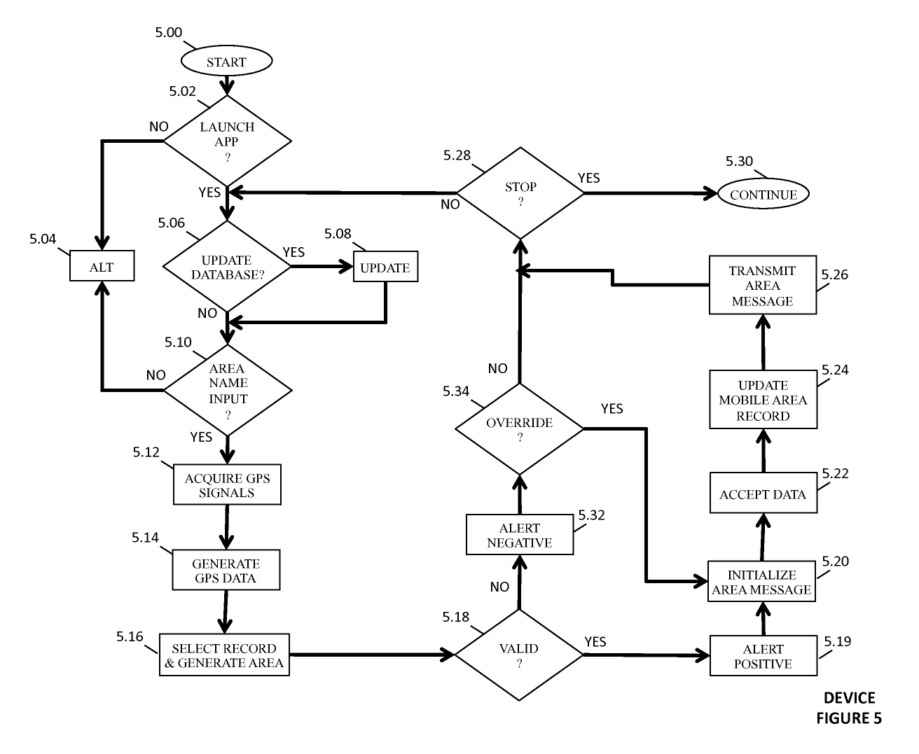

Referring now generally to the Figures and particularly to the flowcharts of FIG. 5 through FIG. 9, in the interest of clarity of explanation certain exemplary data, exemplary electronic records and exemplary electronic messages will be referred to. It is understood that each exemplary electronic record and exemplary electronic message referred to in the Detailed Description are not meant as limitations, but as being representative of alternate exemplary electronic records and exemplary electronic messages that comprise and provide alternate information related to additional instances of the application of the invented method.

Referring now generally to the Figures, and particularly to FIG. 5, FIG. 5 is a flowchart of certain aspects of the invented method relating to the collection and verification of GPS data by the mobile device 2. An exemplary instance of execution of the method of FIG. 5 will now be disclosed.

In step 5.02 the mobile device 2 determines whether the user directs the mobile device 2 to launch a device software application SW.8 for the purposes of (a.) downloading information of one or more area records AREC.001-AREC.N from the DB server 12 and/or the network computer 12; and/or (b.) receiving a user inputted first area name NM.001 and a first GPS mobile data MOB.GPS.001. The first area name NM.001 may be input into the mobile device in step 5.10 by one or more means, to include the input module 2F, the bar code reader 2E, the RFID writer/reader 2M, the wireless communications module 2K, and/or the media reader 2I. The user may apply the input module 2F to direct the mobile device 2 to launch the device software application SW.8.

If the determination in step 5.02 is negative, i.e., the user has not directed the mobile device 2 to launch the device software application in step 5.02, the mobile device 2 proceeds to step 5.04, wherein the mobile device 2 proceeds on to execute alternate processes.

When the determination in step 5.02 is positive, i.e, the user has directed the mobile device 2 to launch the device software application in step 5.02, the mobile device 2 determines whether to update area data records AREC.001-AREC.N of one or more mobile software databases DBS.1-DB.N in step 5.06.

If the mobile device 2 determines to update one or more mobile software databases DBS.1-DB.N in step 5.06, the mobile device 2 proceeds to step 5.08, wherein the mobile device 2 updates the one or more mobile software databases DBS.1-DB.N in step 5.06 by download of area data records AREC.001-AREC.N, and/or by download of information for insertion into one or more area data records AREC.001-AREC.N, from the network computer 10 and/or the DB server 12. The mobile device proceeds from step 5.08 to step 5.10.

Alternately, if the mobile device 2 determines not to update one or more mobile software databases DBS.1-DB.N in step 5.06, the mobile device 2 advances from step 5.06 to step 5.10 wherein the mobile device 2 determines whether the user has input an area name NM.001-NM.N associated with at least one area record AREC.001-AREC.N.

The user may input an area name NM.001-NM.N in step 5.10 either by means of the input module 2F by typing or by use of a drop down menu (not shown) presented by a display screen 2G.1 of the display module 2G and the input module 2F. If the mobile device 2 does not detect a user input of an area name NM.001-NM.N, the mobile device 2 proceeds from step 5.10 to step 5.04 and executes alternate processes.

Alternatively, when the mobile device 2 does detect a user input of an area name NM.001-NM.N in steps 5.12 through 5.16, the mobile device 2 proceeds onto step 5.12 wherein it determines whether the user inputted area name NM.001-NM.N of step 5.10 is valid. Validity of a user inputted area name NM.001-NM.N is determined by the mobile device 2 (a.) receiving GPS signals rom the GPS source 14 in step 5.12; (b.) deriving a mobile GPS data MOB.GPS.001-MOB.GPS.N by means of the GPS module 2D in step 5.14; (c.) proceeding to step 5.16, wherein an area record AREC.001-AREC.N identified by the area name NM.001-NM.N input by the user in step 5.10 is accessed, wherein the selected area record AREC.001-AREC.N is found in the DBMS DBSW.7 and a mathematical representation of a geographic area defined by GPS data GPS.001-GPS.N contained with the selected area record AREC.001-AREC.N is generated; and (d.) in step 5.18 comparing the newly generated mobile GPS data MOB.GPS.001-MOB.GPS.N of step 5.14 with the mathematical representation of a geographic area definition derived the from selected area record AREC.001-AREC.N in step 5.16 to determine if the newly generated mobile GPS data MOB.GPS.001-MOB.GPS.N expresses a geographic location found with the geographic area defined by the selected area record AREC.001-AREC.N selected in step 5.16. A validity flag FLAG is set to a positive value FLAG.POS or a negative value FLAG.NEG by the device application software SW.8 in step 5.18.

When the device software application SW.8 determines in step 5.18 that the mobile GPS data MOB.GPS.001-MOB.GPS.N generated in step 5.14 indicates a geographic location that falls within the geographic area generated in step 5.16, the mobile device 2 sets the validity flag to a positive value FLAG.POS and proceeds from step 5.18 to optional step 5.19, wherein the mobile device 2 generates and transmits an input alert message ALERT.001-ALERT.N that informs the network computer 10 and optionally the data base server 12 that the mobile device 2 has received and successfully validated a positive finding that the mobile GPS data MOB.GPS.001-MOB.GPS.N of step 5.14 is represents a geographic location found with the geographic area defined by the selected area record AREC.001-AREC.N selected in step 5.16. This reporting of step 5.19 is optionally and may be performed without the mobile device 2 alerting the user to the generation and transmission of the instant input alert message ALERT.001-ALERT.N.

The mobile device 2 proceeds from eithers step 5.18 or step 5.19 to step 5.20 and to initialize am area message AMSG.001-AMSG.N that is formatted to accept data input by the user via the mobile device 2 that is to be associated with the area record AREC.001-AREC.N selected in step 5.16. In step 5.22 the mobile device 2 accepts data from the user and populates the area message AMSG.001-AMSG.N initialized in step 5.20 with the newly input data. In step optional step 5.24 the mobile device 2 optionally updates the locally stored area record AREC.001-AREC.N associated with the area name NM.001-NM.N input in step 5.10. The area message AMSG.001-AMSG.N initialized in step 5.20 and populated with data in step 5.22 is sent to the network computer 10 and/or the DB server 12 via the network 4 in step 5.26. The mobile device proceeds from step 5.26 and to step 5.28, wherein the mobile device 2 determines whether to proceed to step 5.06 or, in the alternative, to proceed on to step 5.30 and to cease executing the device software application SW.8.

Referring now to step 5.18, when the mobile device 2 determines in step 5.18 that the mobile GPS data MOB.GPS.001-MOB.GPS.N generated in step 5.14 does not indicate a geographic location that falls within the geographic area definition generated in step 5.16, the mobile device 2 sets the validity flag to the negative value FLSG.NG and proceeds from step 5.18 to optional step 5.32 and generates and transmits an input alert message ALERT.001-ALERT.N that informs the network computer 10 and optionally the data base server 12 that the mobile device 2 has not received and successfully validated a positive finding that the mobile GPS data MOB.GPS.001-MOB.GPS.N generated in step 5.14 does not indicate a geographic location that falls within the geographic area definition generated in step 5.16. In optional step 5.34, the mobile device 2 receives an override message OVMSG.001-OVMSG.N from the network computer 10 that directs the mobile device to proceed from step 5.34 and to step 5.20, whereby the mobile device 2 is directed and enabled to initialize, populate and transmit an area message AMSG.001-AMSG.N despite the finding of step 5.18.

It is understood that in the method of FIG. 5, the user is not alerted by the mobile device 2 of a finding of step 5.18 that the mobile device 2 has not received and successfully validated a positive finding that the mobile GPS data MOB.GPS.001-MOB.GPS.N generated in step 5.14 indicates a geographic location that falls within the geographic area definition generated in step 5.16. It is understood that in the method of FIG. 5, the user is not alerted by the mobile device 2 of a receipt of the override message OVMSG.001-OVMSG.N in step 5.34. The user may thereby be unaware that the mobile device 2 is proceeding through steps 5.10 through 5.26 despite both the negative finding of step 5.18 and the informing of the network computer 10 in step 5.34 of this negative finding of step 5.18.

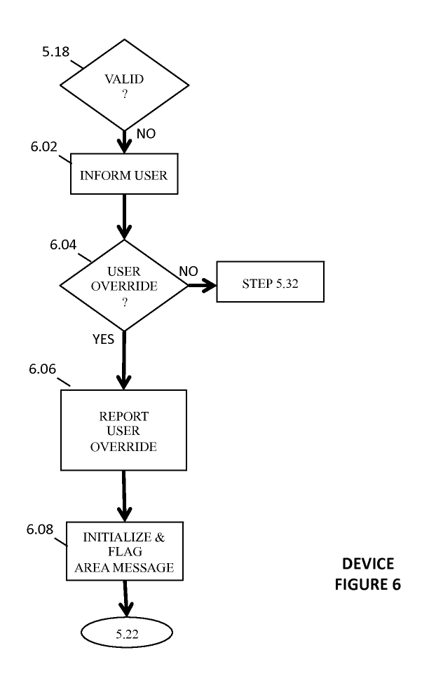

Referring now generally to the Figures and particularly to FIG. 6, FIG. 6 is a flowchart of a further optional aspects of the invented method whereby the mobile device 2 in step 6.02 optionally informs the user of a finding of an invalid area name NM.001-NM.N as input in step 5.10. In step 6.04 the device software application SW.8 determines whether the user has directed the mobile device 2 to override the invalid finding of step 5.18 and to proceed on to authorize performance of the process of steps 5.22 through 5.26. If the determination in step 6.04 is that a user override command is not received by the mobile device 2, the mobile device 2 returns to step 5.32 of the method of FIG. 5. If the determination in step 6.04 is that a user override command has been received by the mobile device 2, the mobile device 2 reports the receipt of the user override command to the network computer 10 in step 6.06, and proceeds on to step 6.08 to initialize a new area message AMSG.001-AMSG.N and therein mark the newly generated area message AMSG.001-AMSG.N with a user override authorization AUTH.001-AUTH.N. The mobile device 2 proceeds from step 6.08 to step 5.22 of step FIG. 5.

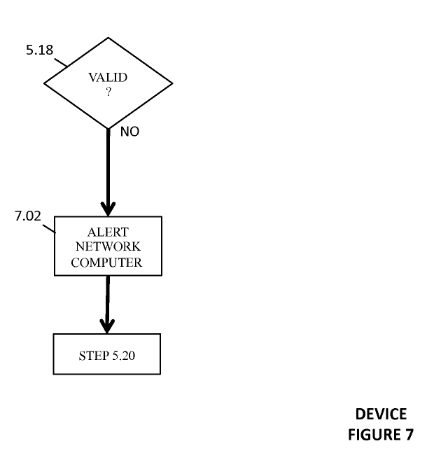

Referring now generally to the Figures and particularly to FIG. 7, FIG. 7 is a flowchart of a yet further optional aspects of the invented method, wherein the device application software SW.8 directs the mobile device 2 to not inform the user of a negative finding of step 5.18, and simply transmit notification of the negative finding in an electronic message in step 7.02 to the network computer 10. The mobile device 2 proceeds form step 7.02 and to step 5.20 without informing the user of the notification action of step 7.02. More particularly, the mobile device 2 in step 5.28 does not find that the mobile GPS data MOB.GPS.001-MOB.GPS.N generated in step 5.14 indicates a definition location that falls within the geographic area definition generated in step 5.16, the mobile device proceeds form step 5.18 to step 7.02 to generate and transmit an alert message ALERT.001-ALERT.N that contains an indication of the instant negative finding of step 5.18. The mobile device 2 then automatically proceeds on from step 7.02 to step 5.20 and without requiring an override instruction from either the user or the network computer 10.

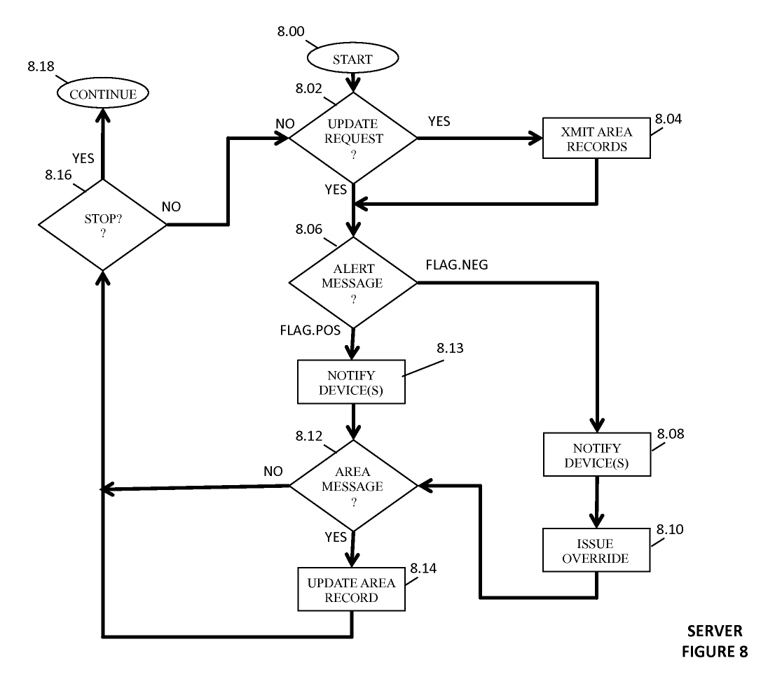

Referring now generally to the Figures and particularly to FIG. 8, FIG. 8 is a flowchart of a additional aspects of the invented method of the network computer 10. In step 8.02 network computer 10 determines whether it has received an update request UREQ.001-UREQ.N from the mobile device 2. If the determination in step 8.02 is positive, the network computer 10 transmits one or more selected area records AREC.001-AREC.N in step 8.04 to the mobile device 2. Once the network computer 10 has transmitted the selected data record 24, or alternately if the determination in step 8.02 is negative, the network computer 10 next determines in step 8.06 whether an alert message ALERT.001-ALERT.N from the mobile device 2 that indicates an input of an invalid area name NM.001-NM.N by the user in step 5.10. This determination of step 8.06 may be effected by determining whether a received alert message ALERT.001-ALERT.N include a positive flag FLAG.POS or a negative flag FLAG.NEG.

It is noted that an activity message ACT.001-ACT.N may be generated and transmitted by the network computer 10 in step 8.07 when the network computer 10 determines that an alert message ALERT.-001-ALERT.N examined in step 8.06 includes a positive flag FLAG.POS,

It is understood that a finding of invalidity of an input of an area name NM.001-NM.N in step 5.10 is determined by a finding in step 5.18 that the mobile GPS data MOB.GPS.001-MOB.GPS.N generated in step 5.14 indicates a geographic location that does not fall within the geographic area definition generated in step 5.16.

If the network computer 10 determines in step 8.06 that the network computer 10 has received an alert message ALERT.001-ALERT.N from the mobile device 2 that includes a negative flag FLAG.NEG indicating an invalid input of an area name NM.001-NM.N, the network computer 10 proceeds from step 8.06 to optional step 8.08, wherein the network computer 10 notifies one or more network devices 11 of the network 4 of the notice of the alert message ALERT.001-ALERT.N received in step 8.06. The notification of step 8.08 may be accomplished by the generation of an activity alert message ACT.001-ACT.N by the network computer 10 and the transmission of the generated activity alert message ACT.001-ACT.N to one or more network devices 11.

The network computer 10 optionally generates and transmits an override message OVMSG.001-OVMSG.N in step 8.10 and proceeds to step 8.12 from either steps 8.07, 8.08 or 8.10, wherein the network computer 10 determines whether an area message AMSG.001-AMSG.N has been received from the mobile device 2.

When receipt of an area message AMSG.001-AMSG.N has been detected by the network computer 10 in step 8.12, the network computer 10 proceeds on to step 8.14 to update an associated record. In the alternative when no area message receipt is detected by the computer network 10 in step, the network computer 10 proceeds from either step 8.12 or step 8.14 to step 8.16. In step 8.16 the network computer 10 determines whether to proceed back to an additional execution of step 8.02 or in the alternative to proceed on to step 8.18 to perform additional computational processes.

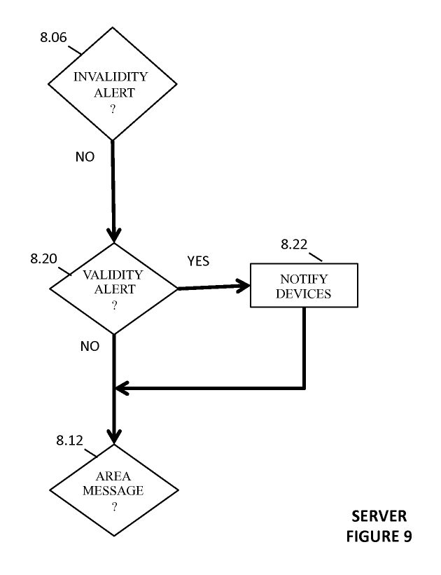

Referring now generally to the Figures and particularly to FIG. 9, FIG. 9 is a flowchart of additional optional aspects of the invented method of the network computer 10. In optional step 8.20, the network computer 10 determines if the network computer 10 has received an alert message ALERT.001-ALERT.N from the mobile device 2 indicating an valid input of an area name NM.001-NM.N, the network computer 10 proceeds from step 8.20 to optional step 8.2, wherein the network computer 10 notifies one or more network devices 11 of the network 4 of the notice of the alert message ALERT.001-ALERT.N received in step 8.20. the network computer proceeds from either step 8.20 or step 8.22 to step 8.12.

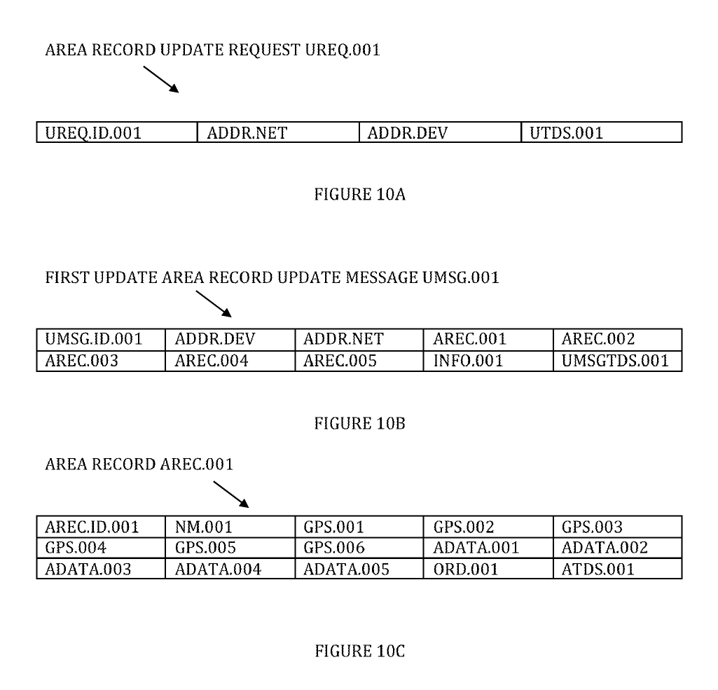

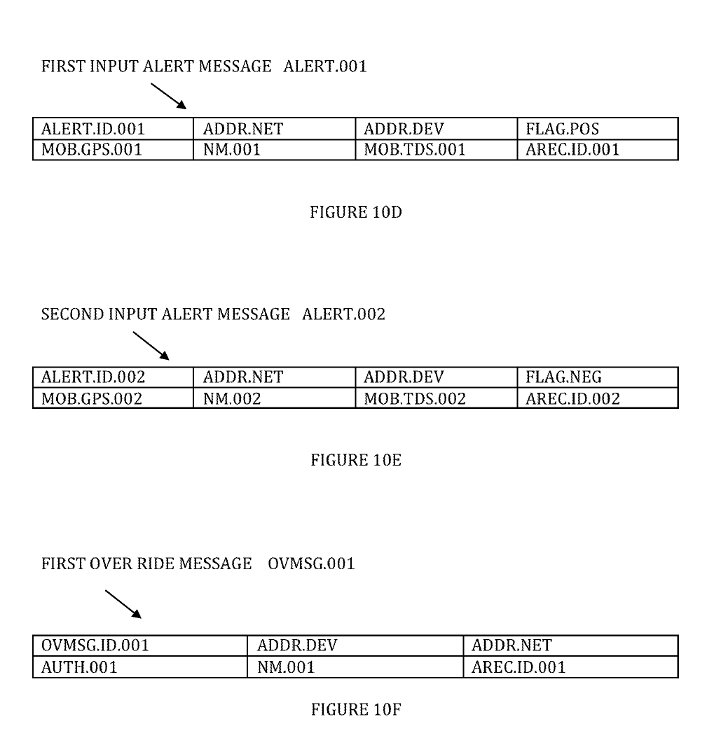

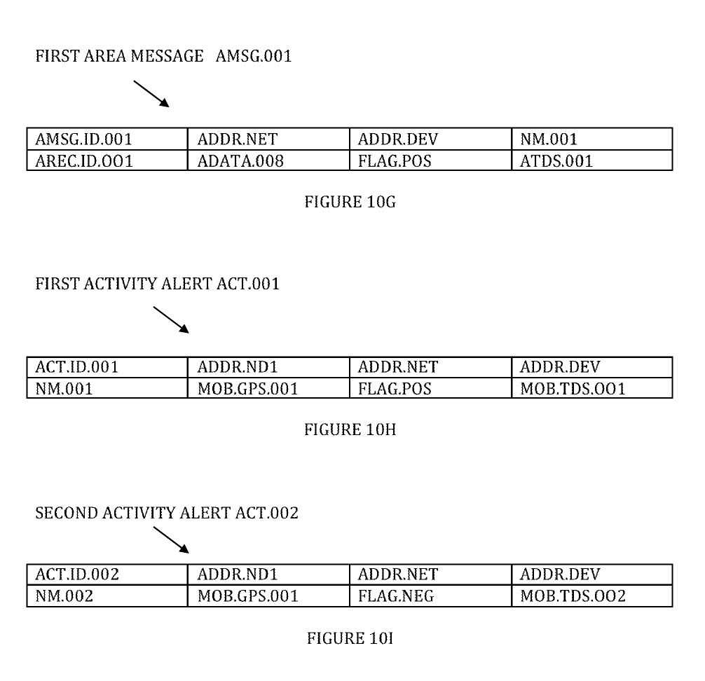

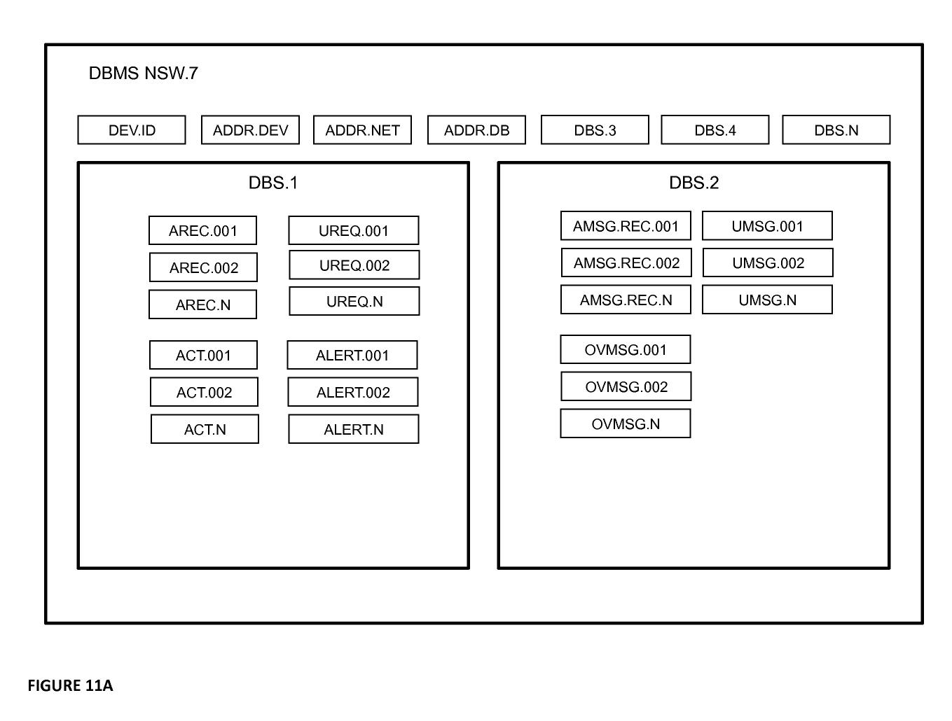

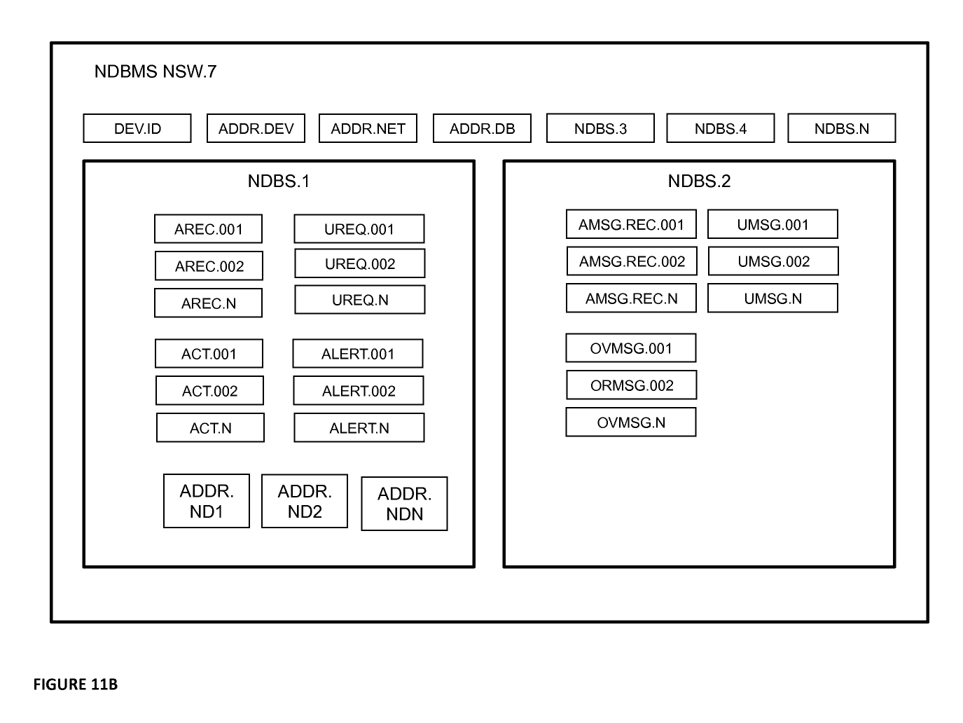

Referring now generally to the Figures and particularly to FIG. 10A, FIG. 10A is a block diagram of an exemplary first area record update request message UREQ.001 step 5.06 of FIG. 5. Update request messages UREQ.001-UREQ.N are transmitted form the mobile device 2 to either the network computer 10 or the DB server 12 and request that an update of area records AREC.001-AREC.N be sent to the requesting mobile device 2. The first area update request message UREQ.001 includes an area update request message identifier UREQ.ID.001. the network computer network address ADDR.NET as a destination address, the mobile device address ADDR.MOB as a sender address and a first update time data stamp UTDS.001. It is understood that an area record update request message UREQ.002-UREQ.N may be addresses to the DB server 12 in an alternate update request message UREQ.002-UREQ.N, wherein the data base server network address ADDR.DB is provided as the destination address within the relevant area record update request message UREQ.002-UREQ.N. The first update time date stamp UTDS.001 is preferably applied by the network computer 12 to distinguish which information and area records AREC.001-AREC.N to send in response to the first update message UMSG.001 and to avoid redundantly sending information and area records AREC.001-AREC.N to the mobile device 2 that had previously been transmitted to the mobile device 2.

Referring now generally to the Figures and particularly to FIG. 10B, FIG. 10B is a block diagram of an exemplary first area record update message UMSG.001. The first area record update message UMSG.001 includes an area update message identifier UMSG.ID.001, the mobile device address ADDR.MOB as a destination address, the network computer network address ADDR.NET as a sender address, preferably a plurality of area records AREC.001-AREC.005, optionally additional update information INFO.001, and preferably an update message time date stamp UMSGTDS.001. It is understood that the DB server may transmit area record update message UMSG.002-UMSG.N, wherein the DB server network address ADDR.DB is included as a sender address. Area record update messages may be transmitted in step 8.04 of the method of FIG. 8.

Referring now generally to the Figures and particularly to FIG. 10C, FIG. 10C is a block diagram of an exemplary first area record AREC.001. The first area record includes a first area record identifier AREC.ID.001, a first area name NM.001, a plurality of GPS location data GPS.001-GPS.006, a plurality of area data ADATA.001-ADATA.005, a first ordering logic ORD.001 and a first area record time date stamp ATDS.001. The plurality of GPS location data GPS.001-GPS.006 are applied by the method of FIG. 5 in view of the first ordering logic ORD.001 to generate a mathematical representation of a first geographic area identified by the first area name NM.001. As each GPS location data GPS.001-GPS.006 identifies a particular geographic location point, and wherein more than three points can be applied to define more than one area, the first area record AREC.001 includes the first ordering logic ORD.001 that instructs the device application software SW.8 the ordering arrangement and linkages of the GPS location data GPS.001-GPS.006 that define the first geographic area that is identified by first area name NM.001.

The each of the plurality of area data ADATA.001-ADATA.N preferably encode information relevant to the first geographic area. The first area record time date stamp ATDS.001 may identified the most recent time and date of an update action of the first area record AREC.001.

It is understood that selected area records AREC.001-AREC.N are provided to the mobile device 2 by the network server 10 or the DB server 12 area record update messages UMSG.001-UMSG.N.

Referring now generally to the Figures and particularly to FIG. 10D, FIG. 10D is a block diagram of an exemplary first input alert message ALERT.001 of step 5.19 of the process of FIG. 5. The first input alert message ALERT.001 includes a first alert message identifier UMSG.ID.001, the network computer network address ADDR.NET as a destination address, the mobile device address ADDR.MOB as a sender address, a positive location match flag FLAG.POS, a first mobile GPS data MOB.GPS.001, the first area name NM.001, optionally a first mobile GPS data time date stamp MOB.TDS.001, and optionally the first area record identifier AREC.ID.001. The positive location match flag FLAG.POS indicates an validity determination of step 5.18, wherein the mobile device 2 determined that the first mobile GPS data MOB.GPS.001 generated in step 5.14 does identify a geographic location found within a mathematical representation of the first geographic area as derived by the mobile device 2 in step 5.16. It is understood that the first area name NM.001 was input by the user into the mobile device 2 in step 5.10.

The first mobile GPS data time date stamp MOB.TDS.001 indicates the date and time of the generation of the first mobile GPS data MOB.GPS.001 of step 5.14. The first area record identifier AREC.ID.001 identifies the first area record AREC.001 that is associated with the first area name NM.001 input by the user into the mobile device 2 in step 5.10.

Referring now generally to the Figures and particularly to FIG. 10E, FIG. 10E is a block diagram of an exemplary second input alert message ALERT.002 of step 5.32 of an alternate instantiation of the process of FIG. 5. The second input alert message ALERT.002 includes a second alert message identifier UMSG.ID.002, the network computer network address ADDR.NET as a destination address, the mobile device address ADDR.MOB as a sender address, a negative location match flag FLAG.NEG, a second mobile GPS data MOB.GPS.002, the second area name NM.002, optionally a second mobile GPS data time date stamp MOB.TDS.002, and optionally the second area record identifier AREC.ID.002. The negative location match flag FLAG.NEG indicates an validity determination of step 5.18, wherein the mobile device 2 determined that the second mobile GPS data MOB.GPS.002 generated in step 5.14 does identify a geographic location found within a mathematical representation of the second geographic area as derived by the mobile device 2 in step 5.16. It is understood that the second area name NM.002 was input by the user into the mobile device 2 in step 5.10.

The second mobile GPS data time date stamp MOB.TDS.002 indicates the date and time of the generation of the second mobile GPS data MOB.GPS.002 of step 5.14. The second area record identifier AREC.ID.002 identifies the second area record AREC.002 that is associated with the second area name NM.002 input by the user into the mobile device 2 in step 5.10.

Referring now generally to the Figures and particularly to FIG. 10F, FIG. 10F is a block diagram of an exemplary first override message OVMSG.001 of step 5.34 of FIG. 5 of step 8.10 of FIG. 8. The first override message OVMSG.001 includes a first override message identifier OVMSG.ID.001, the mobile device address ADDR.MOB as a destination address, the network computer network address ADDR.NET as a sender address, a first authorization code AUTH.001, optionally the first name NM.001, and optionally the first area record identifier AREC.ID.001. The first authorization code AUTH.001 directs the mobile device 2 to proceed from step 5.34 to step 5.20.

Referring now generally to the Figures and particularly to FIG. 10G, FIG. 10G is a block diagram of an exemplary first area message AMSG.001 of steps 5.20 through 5.26 of FIG. 5. The first area message AMSG.001 includes a first area message identifier UMSG.ID.002, the network computer network address ADDR.NET as a destination address, the mobile device address ADDR.MOB as a sender address, optionally the first area name NM.001, preferably the first area record identifier AREC.ID.001, a newly input first area data DATA.008, a positive validity flag FLAG.POS, and an optional first area message time date stamp ATDS.001. It is understood that alternate area messages AMSG.002-AMSG.N may include a negative validity flag FLAG.NEG, such as when the related determination of step 5.18 is negative and an also related override message OVMSG.001-OVMSG.N is subsequently issued by the network computer 10 in an instantiation of step 8.10 of FIG. 8 and received by the mobile device 2 in an instantiation of step 5.34. The override authorization code AUTH.001 of a related override message OVMSG.001-OVMSG.N may optionally be included in an area message AMSG.001-AMSG.N.

The new data DATA.008 is input into the mobile device in step 5.22 by one or more means, to include the input module 2F, the bar code reader 2E, the RFID writer/reader 2M, the wireless communications module 2K, and/or the media reader 2I.

Referring now generally to the Figures and particularly to FIG. 10H, FIG. 10H is a block diagram of an exemplary first device activity message ACT.001 of step 8.15 of FIG. 8. The first device activity message ACT.00a informs a first network device 11 that the first mobile device 2 is determined to be within the first geographic area at the time of generation of first alert message ALERT.00s the by the mobile device 2.

The first device activity message ACT.001 includes a first activity message identifier ACT.ID.001, a first network address ADDR.ND1 of a first network device 11 as a destination address, the network computer network address ADDR.NET as a sender address, the mobile device network address ADDR.DEV, the positive validity flag FLAG.POS generated in a related execution of step 5.18, the first mobile device GPS data MOB.DATA.001 as generated in step 5.14, optionally the first area name NM.001, optionally the first mobile device GPS data time date stamp MOB.DTS.001, and optionally the first area record identifier AREC.ID.001.

The first device activity message ACT.001 informs the first network device 11 that the user has input the first name NM.001 into the mobile device 2 coincident with a finding by the mobile device 2 in step 5.18 that the first mobile device GPS data MOB.DATA.001 falls within the representation of the interior of the first geographic area as derived in step 5.16 by the mobile device 2 from the first area record AREC.001.

Referring now generally to the Figures and particularly to FIG. 10I, FIG. 10I is a block diagram of an exemplary second device activity message ACT.002 of step 8.08 of FIG. 8 sent in response to a receipt by the network computer 10 in step 8.06 of the second alert message ALERT.002 generated in an execution of step 5.32 of FIG. 5. It is understood that the second alert message ALERT.002 included the negative flag FLAG.NEG. The second device activity message ACT.002 informs the first network device 11 that the first mobile device 2 is not determined to be within the second geographic area at the time of generation of second alert message ALERT.002 the by the mobile device 2.

The second device activity message ACT.002 includes a second activity message identifier ACT.ID.002, the first network address ADDR.ND1 of a first network device 11 as a destination address, the network computer network address ADDR.NET as a sender address, the mobile device network address ADDR.DEV, the second mobile device GPS data MOB.DATA.002 as generated in step 5.14, the negative validity flag FLAG.NEG generated in a related execution of step 5.18, optionally the second mobile device GPS data time date stamp MOB.DTS.001, optionally the second area name NM.002, optionally the first mobile device GPS data time date stamp MOB.DTS.001, and optionally the second area record identifier AREC.ID.002.

The second device activity message ACT.002 informs the first network device 11 that the user has input the second name NM.002 into the mobile device 2 coincident with a finding by the mobile device 2 in step 5.18 that the second mobile device GPS data MOB.DATA.002 does not fall within the representation of the interior of a second geographic area as derived in step 5.16 by the mobile device 2 from the second area record AREC.002.

It is understood that one or more activity messages sent by the network computer 10 may be addressed to two or more network devices 11.

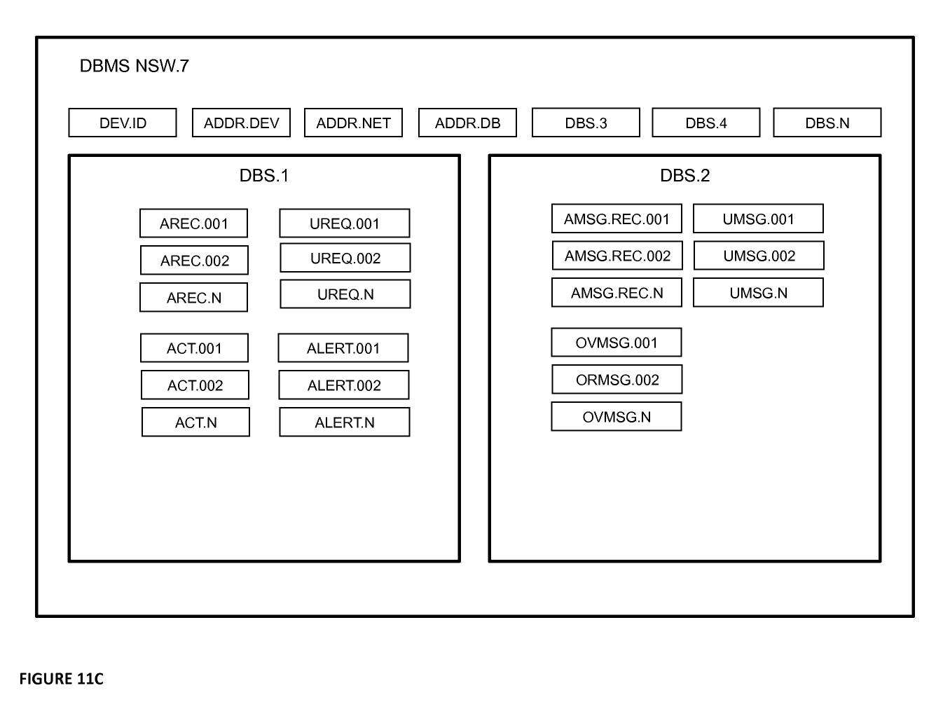

Referring now generally to the Figures and particularly to FIG. 11A, FIG. 11A is a block diagram of the DBMS DBSW.7 of the mobile device 2 maintaining electronic messages UREQ.01-UREQ.N, UMSG.001-UMSG.N, OVMSG.001-OVMSG.M, AMSG.001-AMSG.002, ALERT.001-ALERT.N ACT.001-ACT.N and area records AREC.001-A.REC.N.

Referring now generally to the Figures and particularly to FIG. 11B, FIG. 11B is a block diagram of the network computer data base management system NDBMS NSW.7 of the network computer 10 maintaining electronic messages UREQ.01-UREQ.N, UMSG.001-UMSG.N, OVMSG.001-OVMSG.M, AMSG.001-AMSG.002, ALERT.001-ALERT.N ACT.001-ACT.N and area records AREC.001-A.REC.N.

Referring now generally to the Figures and particularly to FIG. 11C, FIG. 11C is a block diagram of the DB server base management system DB DBMS DBSW.7 of the DB server 12 maintaining electronic messages UREQ.01-UREQ.N, UMSG.001-UMSG.N, OVMSG.001-OVMSG.M, AMSG.001-AMSG.002, ALERT.001-ALERT.N ACT.001-ACT.N and area records AREC.001-A.REC.N.

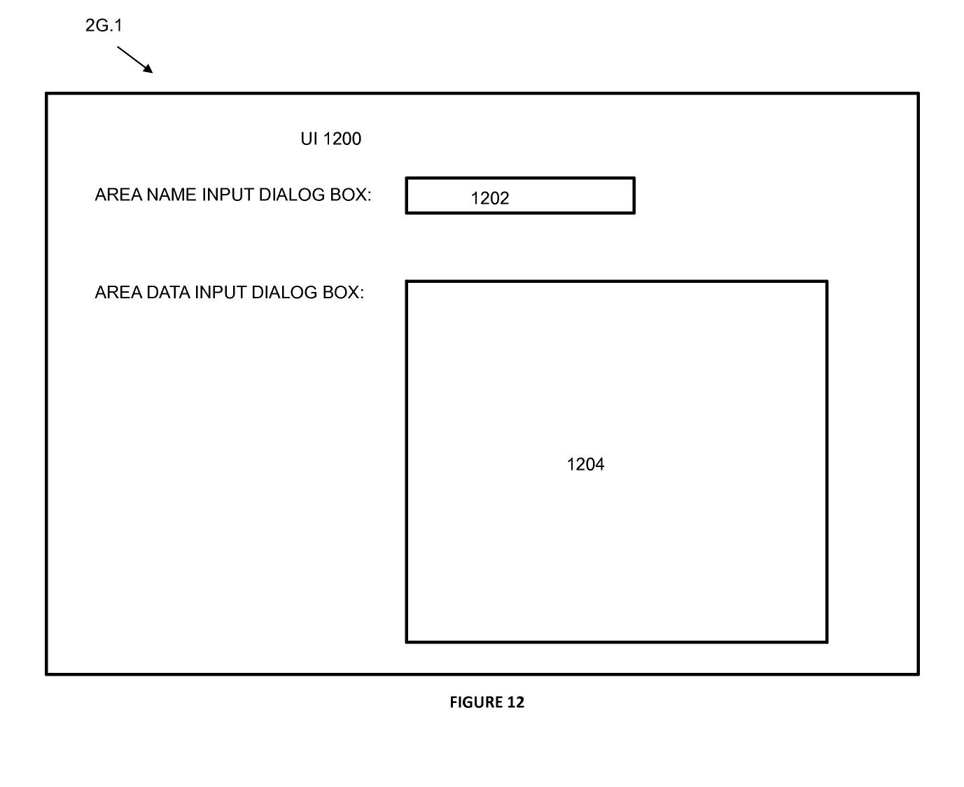

Referring now generally to the Figures and particularly to FIG. 12, FIG. 12 is an illustration of a visual rendering of a user interface 1200 of the mobile device 2 as presented on the display screen 2G.1 of the display module 2G of the mobile device 2. A first dialog box 1202 enables the user to input an area name NM.001-NM.N into the device software application SW.7, electronic messages AMSG.001-AMSG.N, ALERT.001-ALERT.N ACT.001-ACT.N and one or more area records AREC.001-A.REC.N. A second dialog box 1204 enables the user to input area data DATA.001-DATA.N, such as the new area data DATA.008, into the device software application SW.7, one or more area messages AMSG.001-AMSG.001, ALERT.001-ALERT.N ACT.001-ACT.N and one or more area records AREC.001-A.REC.N.

The area names NM.001-NM.N and the data DATA.001-DATA.N may be input into the user interface 1200 of mobile device by one or more means, to include the input module 2F, the bar code reader 2E, the RFID writer/reader 2M, the wireless communications module 2K, and/or the media reader 2I. The user may apply the input module 2F to direct the mobile device 2 to launch the device software application SW.8.

The foregoing disclosures and statements are illustrative only of the present invention, and are not intended to limit or define the scope of the present invention. The above description is intended to be illustrative, and not restrictive; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

We claim:

1. A computer-implemented method of associating user reported location data with automatically generated geolocational data, the method comprising:
a. downloading a plurality of area records to a mobile device, the mobile device adapted for wireless communications and comprising a geolocational module, and each of the plurality of records comprising an area defined by geolocational data;
b. accepting a user input representing that an attestation of a simultaneous location of the mobile device as being within an area described by an area record;
c. generating by the geolocational module a generated user geolocational data, the generated user geolocational data representing a measured location of the mobile device;
d. determining whether the generated user geolocational data represents a location within the area described by an area record of the plurality of area records; and
e. enabling interaction with the user in accordance with the determination of step d.

2. The method of claim 1, further comprising:
f. a determination that the generated user geolocational data does represent a location within the area described by an area record of the plurality of area records; and
g. enabling a data input by the mobile device in association with area record determined in step f.

3. The method of step 2, further comprising the mobile device transmitting a report of the area record determination of step f.

4. The method of claim 1, further comprising:
f. a determination that the generated user geolocational data does not represent a location within the area described by any area record of the plurality of area records; and
g. disabling a data input in association with any area record.

5. The method of claim 4 further comprising the mobile device alerting the user of the disabling of step g.

6. The method of claim 4 further comprising the mobile device transmitting a report of the user of the disabling of step g to a computational device.

7. The method of claim 4 further comprising:
h. enabling a data input by the mobile device in association with area record determined in step f; and
i. the mobile device transmitting a report of the determination that the generated user geolocational data does not represent a location within the area described by any area record of the plurality of area records.

8. The method of claim 4, further comprising:
h. accepting an override command from the user; and
i. enabling a data input by the mobile device in association with area record determined in step f;
j. the mobile device transmitting a report of the determination that the generated user geolocational data does not represent a location within the area described by any area record of the plurality of area records.

9. The method of claim 4, further comprising:
h. the mobile device transmitting a report of the determination that the generated user geolocational data does not represent a location within the area described by any area record of the plurality of area records;
i. accepting an override command from a remote device; and
i. enabling a data input by the mobile device in association with area record determined in step f.

10. A computer-implemented method of associating user reported location data with automatically generated geolocational data, the method comprising:
a. downloading a plurality of area records to a mobile device, the mobile device adapted for wireless communications and comprising a geolocational module, and each of the plurality of records comprising an area defined by geolocational data;
b. receiving an area identifier selection from the user;
c. selecting an area record identified by the selected area identifier;
d. determining whether the generated user geolocational data represents a location within the area described by the selected area record; and
e. enabling interaction with the user in accordance with the determination of step c.

11. The method of claim 10, further comprising:
f. a determination that the generated user geolocational data does represent a location within the area described by an area record of the plurality of area records; and
g. enabling a data input by the mobile device in association with area record determined in step f.

12. The method of step 11, further comprising the mobile device transmitting a report of the area record determination of step f.

13. The method of claim 10, further comprising:
f. a determination that the generated user geolocational data does not represent a location within the area described by any area record of the plurality of area records; and
g. disabling a data input in association with an area record.

14. The method of claim 13, further comprising the mobile device alerting the user of the disabling of step g.

15. The method of claim 13, further comprising the mobile device transmitting a report of the user of the disabling of step g to a computational device.

16. The method of claim 13, further comprising:
h. enabling a data input by the mobile device in association with area record determined in step f; and
i. the mobile device transmitting a report of the determination that the generated user geolocational data does not represent a location within the area described by any area record of the plurality of area records.

17. The method of claim 13, further comprising:
h. accepting an override command from the user;
i. enabling a data input by the mobile device in association with area record determined in step f; and
j. the mobile device transmitting a report of the determination that the generated user geolocational data does not represent a location within the area described by any area record of the plurality of area records.

18. The method of claim 13, further comprising:
h. the mobile device transmitting a report of the determination that the generated user geolocational data does not represent a location within the area described by any area record of the plurality of area records;
i. accepting an override command from a remote device; and
i. enabling a data input by the mobile device in association with area record determined in step f.

19. A computer-implemented method of associating user reported location data with automatically generated geolocational data, the method comprising:
a. accepting a user attestation of a simultaneous location of a mobile device, the mobile device adapted for wireless communications and comprising a geolocational module;
b. accepting a user input datum;
c. generating by the geolocational module a geolocational data, the geolocational data representing a measured location of the mobile device; and
d. reporting the user attestation, the geolocational data and the user input datum by wireless transmission to a computational device.

20. The method of claim 19, further comprising a rendered representation of a form by a visual display of the mobile device, and the user input datum received as an input to a dialogue box of the rendered representation of the form.
